(19) United States
(12) Patent Application Publication
(10) Pub. No.: US 2026/0219901 A1
(43) Pub. Date: Jul. 30, 2026

(54) INTERACTIVE REPOSITORY TASK ACCELERATING USER INTERFACE

(71) Applicant: INTERNATIONAL BUSINESS MACHINES CORPORATION, Armonk, NY (US)

(72) Inventors: Shreyas HIREMATH, Bangalore (IN); Parineeta Divakar MATTUR, Bengaluru (IN); Shwetha GOPALAKRISHNA, Bangalore (IN); Sudhakar T. SESHAGIRI, Bangalore (IN); Srini BHAGAVAN, Dublin, CA (US)

(21) Appl. No.: 19/041,595

(22) Filed: Jan. 30, 2025

(51) Int. Cl. G06Q 10/0631; G06F 9/451; G06Q 10/10

(52) U.S. Cl. CPC G06F 9/451; G06F 8/71

(57) ABSTRACT

Methods, computer program products, and systems are presented. The method computer program products, and systems can include, for instance: examining repository data of first through Nth multi-user software project repositories, wherein the first through Nth multi-user software project repositories provide support for respective first through Nth differentiated software projects; identifying, from the examining, current tasks for performance by a certain user, wherein the certain user is associated to respective ones of the first through Nth multi-user software project repositories; generating user prompting data in dependence on the identifying; and presenting the user prompting data generated by the generating to the certain user, wherein the presenting includes presenting a user interface to the certain user, the user interface including the user prompting data.

### BACKGROUND

Embodiments herein relate to software project repositories, and particularly to an interactive task accelerating user interface for use with software project repositories.

A version-controlled (VC) software project repository can include the source code, stored in directories with clear organization; documentation, like README files for project overview and CONTRIBUTING guidelines for collaboration; configuration files for build and runtime settings (e.g., .env, Dockerfile, package.json); test suites to ensure code quality; and branching workflows for feature development. The repository also contains version history with commit logs and tags for releases, and may include CI/CD pipelines for automated testing and deployment. Optional components include issues and pull requests to manage tasks and code reviews, fostering collaboration and traceability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: examining repository data of first through Nth multi-user software project repositories, wherein the first through Nth multi-user software project repositories provide support for respective first through Nth differentiated software projects; identifying, from the examining, current tasks for performance by a certain user, wherein the certain user is associated to respective ones of the first through Nth multi-user software project repositories; generating user prompting data in dependence on the identifying; and presenting the user prompting data generated by the generating to the certain user, wherein the presenting includes presenting a user interface to the certain user, the user interface including the user prompting data.

In another aspect, a computer program product can be provided. The computer program product can include a computer readable storage medium readable by one or more processing circuit and storing instructions for execution by one or more processor for performing a method. The method can include, for example: examining repository data of first through Nth multi-user software project repositories, wherein the first through Nth multi-user software project repositories provide support for respective first through Nth differentiated software projects; identifying, from the examining, current tasks for performance by a certain user, wherein the certain user is associated to respective ones of the first through Nth multi-user software project repositories; generating user prompting data in dependence on the identifying; and presenting the user prompting data generated by the generating to the certain user, wherein the presenting includes presenting a user interface to the certain user, the user interface including the user prompting data.

In a further aspect, a system can be provided. The system can include, for example, a memory. In addition, the system can include one or more processor in communication with the memory. Further, the system can include program instructions executable by the one or more processor via the memory to perform a method. The method can include, for example: examining repository data of first through Nth multi-user software project repositories, wherein the first through Nth multi-user software project repositories provide support for respective first through Nth differentiated software projects; identifying, from the examining, current tasks for performance by a certain user, wherein the certain user is associated to respective ones of the first through Nth multi-user software project repositories; generating user prompting data in dependence on the identifying; and presenting the user prompting data generated by the generating to the certain user, wherein the presenting includes presenting a user interface to the certain user, the user interface including the user prompting data.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a computer environments, client computer devices, and enterprises systems according to one embodiment;

FIG. 2A-2B is a flowchart illustrating a method for performance by a manager system interoperating with UE devices, computer environments, and one or more LLM according to one embodiment;

FIG. 3 is a user interface according to one embodiment;

FIG. 4A-4B is a flowchart illustrating a system according to one embodiment;

FIG. 5 depicts an artificial neural network (ANN) according to one embodiment;

FIG. 6 depicts a computing environment according to one embodiment.

### DETAILED DESCRIPTION

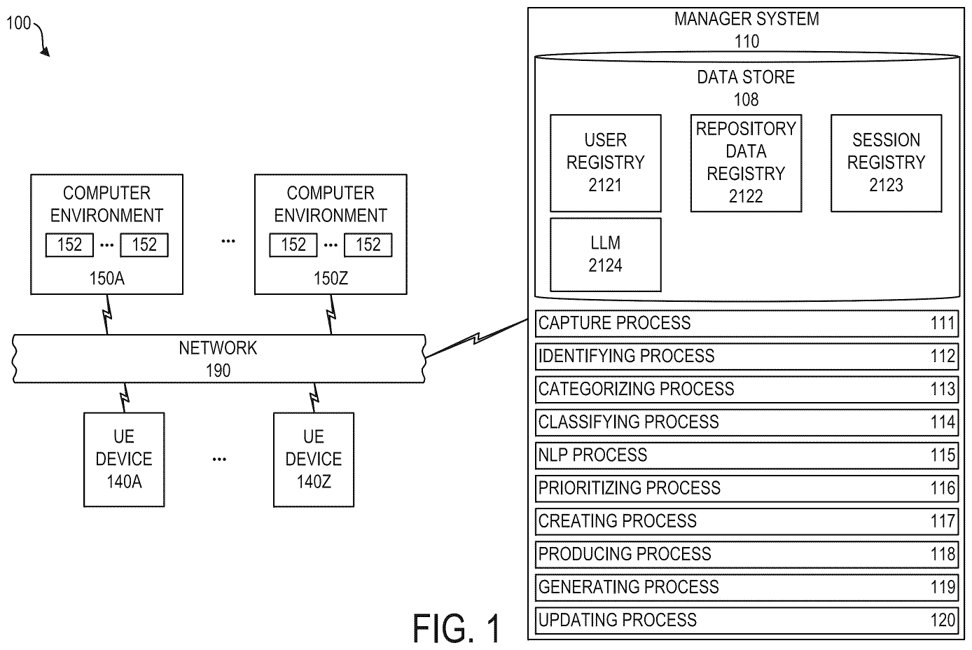

System 100 for use in implementing repository actions is shown in FIG. 1. System 100 can include manager system 110, user equipment (UE) devices 140A-140Z and computer environments 150A-150Z. Manager system 110, UE devices 140A-140Z and computer environments 150A-150Z can be computing node based systems in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In one embodiment, manager system 110 can be external to each computer environment of computer environments and can be external to each UE device of UE devices 140A-140Z. In one embodiment, manager system 110 can be co-located with one or more computer environment of computer environments 150A-150Z and/or one or more UE device of UE devices 140A-140Z. Users of UE devices 140A-140Z can include collaborator users of one or more version control managed software project repository.

In one embodiment, computer environments 150A-150Z can include respective data sources 152. Data sources 152 can include, e.g., storage locations storing repository data of software project repository. In a version-controlled software project repository, a single logical repository can be distributed between a central repository and multiple local repositories. The central repository, often hosted on platforms like GitHub or GitLab, serves as the source of truth, storing the complete project, including branches, commits, and metadata, while enforcing collaboration policies like code reviews. Each contributor has a local repository, a full copy of the central one, stored on their machine, enabling offline work and independent changes. Contributors pull updates from the central repository, make changes, commit them locally, and push them back to the central repository, ensuring synchronization across all collaborators. Data sources 152 can include storage locations of both central repositories and local repositories. Where a data source includes a storage location of a certain UE device of a software project repository user, the certain UE device of UE devices 140A-140Z can define a certain computer environment of computer environments 150A-15Z, and can be co-located with the certain computer environment.

Collaborator users in a version control (VC) managed software project repository are individuals with direct access to contribute to the repository. They typically include developers, who write and modify code; reviewers, who review pull requests and ensure code quality; and project managers, who oversee tasks, track progress, and manage issues. Other collaborators can include designers, contributing assets or UI/UX elements; testers, who add or review test cases; and DevOps engineers, who manage CI/CD pipelines and deployment configurations. Collaborators often have assigned roles and permissions, such as read-only access for reviewers or write access for contributors, ensuring structured and secure collaboration. These users interact with the repository by creating branches, committing changes, and participating in discussions around pull requests and issues, collectively maintaining and improving the software project.

Embodiments herein recognize that computer systems can fail due to management responsibilities of users who can become overwhelmed with performance of tasks in relation to multiple software project repositories to which they have rights.

Embodiments herein recognize that users of software project repositories have become challenged to determine tasks for performance on each repository to which they are associated. In one example, a certain user can have rights in and can be associated multiple repositories, e.g., a first “regular business/product” repository, a second repository for stretch assignments, a third repository for project and/or people management, and a fourth repository for upskilling and training. Embodiments herein recognize that range of manual tasks can be necessitated in order for a certain user to manage tasks in respect to each repository in which they have rights, and the user's lack of awareness of the tasks and/or attention to the tasks can result in diminished performance (including failure) of production ready active codebase code include core branch code in the core branch of a repository. The core branch code serves as the foundation of a project, containing the stable, production-ready version of the application or service. It runs in production environments, such as servers, cloud platforms, or user devices, depending on the project's nature. Running the core branch code can define either an application (e.g., a web or mobile app) or a service (e.g., an API or backend system), based on its design and purpose. This code drives the main functionality that end users interact with, whether it's delivering content, processing requests, or providing services. Its stability ensures reliability and performance in live environments. Embodiments herein recognize that failure to manage updates to core branch code can result in diminished performance (including failure) of active codebase code. In one aspect active codebase code can run on a computer system defined by a computing node of a computing node based computer environment, such as may be provided by one or more computer environment of computer environments 150A-150Z.

A pull request (PR) herein refers collaborative process in Git that allows a developer to request the merging of changes from one branch (often a feature or bug-fix branch) into another, such as the main or develop branch. PRs are a critical step in modern development workflows, providing a platform for collaboration, review, and quality assurance. Typically, a PR includes new code developed by the author or modifications to existing code, but it can also include non-code updates, such as documentation or configuration changes. The process begins when a developer pushes their changes to the repository and opens a PR. At this point, team members, maintainers, or reviewers assess the code for correctness, quality, and adherence to project standards. This review phase often involves discussion, comments, and sometimes requests for revisions or improvements.

Embodiments herein recognize that once all feedback has been addressed and the PR is approved, the next step is merging. Merging integrates the proposed changes from the source branch into the target branch, making the updates available to others. The developer who created the PR might handle the merge if they have the required permissions and the workflow allows it. However, in larger teams or repositories, merging is often done by a reviewer or maintainer to ensure all quality checks are satisfied. PRs and merges work together as two steps in the same workflow: the PR serves as the discussion and review stage, while merging finalizes the process by incorporating the updates into the codebase. This structured process ensures that code changes are well-reviewed, properly tested, and meet project standards before becoming part of the shared repository, helping teams maintain code quality and reduce errors in collaborative environments.

The codebase and the main branch are related but not the same. The codebase refers to the entire collection of code within a project, including all branches (e.g., main, develop, feature branches), the commit history, and all files in the repository. It represents the full scope of the project, encompassing everything in the repository. On the other hand, the main branch is a specific branch within the codebase, typically serving as the primary or production-ready version of the code. It is where final, approved, and tested changes are merged, often acting as the source for building releases or deployments. While the main branch represents the “gold standard” or stable version of the project, the codebase includes all active and inactive branches, including those used for experimental or in-progress work. The relationship between the two lies in the workflow: changes made in feature branches or other parts of the codebase are eventually merged into the main branch, making them part of the “official” version. In essence, the main branch is a central part of the codebase, but the codebase encompasses much more than just the main branch, reflecting the entirety of the project.

Embodiments herein can include features that can expedite the merging of critical updates to a codebase, and can prevent failure of active code of a codebase. Embodiments herein can subject pull request code to a conflict check. On the pull request code successfully passing a conflict check web automated script can be generated for completion of a merge task by a user. Where a conflict is detected, the generation of web automated script can be restricted to prevent merging of conflicting code.

Manager system 110 can include an associated data store 108. Data store 108 can store various data. Data store 108 in the user registry 2121 can store data on registered users of system 100. From time to time, users can define requests to become registered users of system 100. Upon receipt of request by user to become a registered user, manager system 110 can establish a universal unique identifier (UUID). For the user for each registered user, there can be an associated one or more repository used by the user.

In repository data registry 2122, data store 108 can store repository data. Repository data stored in repository data registry 2122 can include, e.g., repository metadata. Repository metadata consists of various types that provide detailed information about different aspects of a repository. Commit metadata captures details about individual commits, including the commit hash, author, committer, date, message, files changed, and parent commits, enabling precise tracking of changes. Pull request (PR) metadata describes proposed changes before merging, including the PR title, description, author, source and target branches, status (open, closed, merged), timestamps (creation, updates, merging), reviews, approvals, linked issues, and files/commits included in the PR. Issue metadata tracks tasks, bugs, or feature requests, detailing the issue title, description, author, status (open, in-progress, closed), labels, assignees, linked pull requests, timestamps, and comments for collaborative discussions. Branch metadata provides insights into repository branches, including their names, last commit (hash, author, date), parent branch, status (active, merged, deleted), associated PRs, and any branch protection rules (e.g., requiring reviews or CI checks). Lastly, test status metadata tracks the outcomes of automated or manual tests, capturing the test name/ID, result (pass, fail, skipped), type (unit, integration, end-to-end), execution time, associated commit or PR, logs, reports, and timestamps for test runs. Together, these metadata types help manage repositories effectively by providing transparency, traceability, and structure to code changes, collaborations, testing, and the overall lifecycle of the project.

Data store 108 in session registry 2123 can store data in support of a current user interface session. Manager system 110 can use data stored in session registrar to generate user prompting data for presentment on a user interface.

Data store 108 in large language model (LLM) area 2124 can store one or more LLM in LLM area 2124. The one or more LLM can be configured to be inferenced with use of model prompting data that prompts an LLM of LLM area 2124 to return, e.g., prioritization data that specifies a prioritization of tasks and/or summary data that specifies a summary of actions to take with respect to one or more repository. An LLM can define a trained machine learning model. Pre-training a Large Language Model (LLM) can be done by training it on large datasets to predict the next word in a sequence (language modeling) or fill in missing text (masked language modeling). The process can involve collecting diverse datasets, such as books, websites, and other text sources, to provide broad linguistic knowledge. The model, often a deep neural network like a Transformer, can be initialized with random weights. During training, it can process input text, generate predictions, and adjust its weights using backpropagation to minimize the loss between predicted and actual outputs. Techniques like tokenization, positional embeddings, and attention mechanisms can enable the model to understand and generate coherent text. Pre-training can require substantial computational resources, such as GPUs or TPUs, and involve millions or billions of parameters. The resulting model can be generalized and fine-tuned for specific tasks.

Manager system 110 can run various processes. Manager system 110 running capture process 111 can include manager system 110 capturing repository data of one or more repository associated to one or more user. To pull repository metadata, manager system 110 can use a combination of Git commands, platform-specific APIs (like GitHub, GitLab, or Bitbucket), or automation tools. Commit metadata can be retrieved using commands like git log to view commit history (hash, author, date, message) and git show for file changes in a specific commit. Alternatively, the GitHub API (/commits) can fetch detailed commit information for the repository. Pull request (PR) metadata is accessible through APIs like GitHub's/pulls endpoint or GitLab's/merge requests endpoint, which provide details such as the PR title, description, branches involved, status, timestamps, and associated files or commits. Manager system 110 can also view PRs manually on platform web interfaces. Issue metadata, including the title, description, author, labels, assignees, status, and comments, can be obtained from APIs (/issues endpoint) or the repository's issue tracking interface. Branch metadata, such as branch names, latest commits, and status, is retrievable using Git commands (git branch, git log) or APIs (/branches endpoint). Test status metadata, which includes results of CI/CD tests (e.g., pass/fail, execution time, logs), is generally integrated into platforms' pipelines and accessible through their CI APIs. Combining these tools provides detailed insights into all repository activities and metadata, enabling efficient project management. Manager system 110 can restrict repository metadata collection to focus on a specific user by applying filters or queries via Git commands, platform APIs (like GitHub, GitLab, or Bitbucket), or custom scripts. For commit metadata, Git allows filtering using the --author flag in commands like git log, which retrieves only the commits authored by a particular user, or APIs like GitHub's/commits, where the author query parameter can isolate the user's contributions. Pull Request (PR) metadata can be filtered to show PRs created by or assigned to a specific user. This can be done through APIs such as GitHub's /pulls endpoint combined with author:username or assignee:username in the query, or directly in platform UIs with search filters. Similarly, issue metadata can be restricted to issues authored or assigned to a user using APIs (/issues) or search filters in the repository's issue tracker. For branch metadata, while Git does not inherently associate branches with users, contributions can be traced by reviewing branches with commits authored by the user using git log --author. Test status metadata, often linked to commits or PRs, can also be narrowed down by identifying tests associated with the user's commits or PRs, and querying CI/CD platforms' APIs for specific runs. Automating this process can involve scripting to integrate Git commands and API calls, dynamically filtering data based on user identifiers like name, email, or username. By combining these tools and methods, repositories can provide detailed user-specific insights into commits, PRs, issues, branches, and test results, ensuring targeted analysis or auditing of contributions while maintaining precision and accuracy.

Manager system 110 running identifying process 112 can include manager system 110 identifying current tasks for performance by a certain user with respect to one or more software project repository. To analyze repository metadata and identify tasks for a specific user, manager system 110 can filter, organize, and interpret data across multiple sources like issues, pull requests (PRs), commits, branches, and test results. Manager system 110 can perform analyzing issue metadata to find open or in-progress issues assigned to the user, prioritizing based on urgency, labels (e.g., bug or enhancement), or deadlines. Use APIs or GitHub's interface to pinpoint tasks the user needs to address. Next, examine PR metadata to identify open PRs authored by or assigned to the user, focusing on those with unresolved review comments, failing tests, or awaiting merging. For commit metadata, track recent contributions using commands like git log --author, looking for incomplete work or commits tied to unresolved issues. Analyze branch metadata to identify active or stale feature branches owned by the user that require merging, rebasing, or further development. Additionally, use test status metadata from CI/CD tools to identify failed tests related to the user's contributions, highlighting debugging tasks or required reruns. Automating this process through scripts and APIs can aggregate relevant metadata, filter it by the user, and output a prioritized task list organized by urgency, type, and status. This approach ensures an efficient, user-specific workflow tailored to their responsibilities.

Manager system 110 running categorizing process 113 can include manager system 110 categorizing an identified task as a non-code task or a code task. In one embodiment, manager system 110 can return the categorization of code task where repository data of the task is associated to a pull request (PR). Manager system 110 can return the categorization of non-code task in the case that the identified task of the certain user is not a pull request (PR) of the certain user of an identified task.

Manager system 110 running classifying process 114 can include manager system 110 classifying a code task as a code task presenting a code conflict or as a code task not presenting a code conflict. Manager system 110 running classifying process 114 can include manager system 110 checking for code conflicts defined by, e.g., discrepancies, regression issues, and/or failing unit tests, safeguarding the main codebase against potential errors and maintaining high standards of code quality.

Manager system 110 running natural language processing (NLP) process 115 can include manager system 110 subjecting text data captured by capture process 111 to natural language processing to return one or more NLP output parameter. The one or more NLP output parameter can include, e.g., sentiment parameter value and/or subjectivity parameter value. Natural Language Processing (NLP) for polarity sentiment and subjectivity parameter extraction can be performed using a combination of machine learning models, lexicon-based approaches, or deep learning techniques. Polarity sentiment extraction focuses on determining the emotional tone of text, categorizing it as positive, negative, or neutral. This can be achieved using pre-trained models like BERT, which can classify sentiment based on contextual embeddings, or lexicon-based approaches such as SentiWordNet, which match words in the text to predefined sentiment scores. Subjectivity extraction, on the other hand, involves identifying whether a text is subjective (opinionated) or objective (factual). This can be accomplished by training models on datasets annotated with subjectivity labels, using features such as the presence of opinion words, sentence structure, and contextual indicators. Both tasks can leverage supervised learning with labeled datasets or unsupervised methods like clustering to identify patterns. Additionally, NLP pipelines can include tokenization, stopword removal, and dependency parsing to preprocess data and enhance model performance. Combining rule-based methods (e.g., negation handling) with machine learning models can improve accuracy in extracting these parameters, especially in complex or domain-specific text. For NLP parameter determination, repository comment data defined by user comments associated to a task and issue can be subject to natural language processing. In a version control repository, user comments can be found in issues, where they discuss bugs or tasks; pull requests (PRs) associated to issues, where they review and suggest changes; and discussions associated to issues, for broader project topics. Comments can also be in commit messages for context on changes and project boards for task-specific notes. These comments can be accessed via the repository's interface or APIs, aiding in collaboration and task identification.

Manager system 110 running prioritizing process 116 can include manager system 110 prioritizing tasks of a user. Manager system 110 running prioritizing process 116 can include manager system 110 prompting an LLM with a structured prompt configured to provide output of a prioritization score for a task, wherein the structured prompt comprises repository data associated to task, and request data requesting the LLM to provide a prioritization score for the task.

Manager system 110 running creating process 117 can include manager system 110 creating a summary of an identified task of a user. Manager system 110 running creating process 117 can include manager system 110 prompting an LLM with a structured prompt configured to provide output of a summary a task, wherein the structured prompt comprises repository data of a task and request data requesting the LLM to provide a summary the task.

Manager system 110 running producing process 118 can include manager system 110 can include manager system 110 producing web automated script for performance of an identified task. Manager system 110 running producing process 118 can include manager system 110 prompting an LLM with a structured prompt configured to provide output of web script for automation task, wherein the structured prompt comprises repository data of a task and request data requesting the LLM to provide a web automation script for completion of the task.

Manager system 110 running generating process 119 can include manager system 110 generating text prompting data that prompts a user to take action respect to one or more repository. Manager system 110 running user prompting data generating process 115 can include manager system 110 generating user prompting data based on output of one or more process of processes 111-1118. Manager system 110 running user prompting data generating process 115 can include manager system 110 generating user prompting data based on output data output from one or more LLM of LLM area 2124 responsively to inferencing of the one or more LLM using model prompting data. Manager system 110 running generating process 119 can include manager system 110 formatting an HTML web page defining a user interface for serving to a user.

Manager system 110 running updating process 120 can include manager system 110 updating one or more software project repository based on selection data defined by a user responsively to user prompting data being presented to be a registered user on a user interface. The updating can include updating a codebase of one or more software project repository. The updating can include updating production ready core branch code of a repository's core branch.

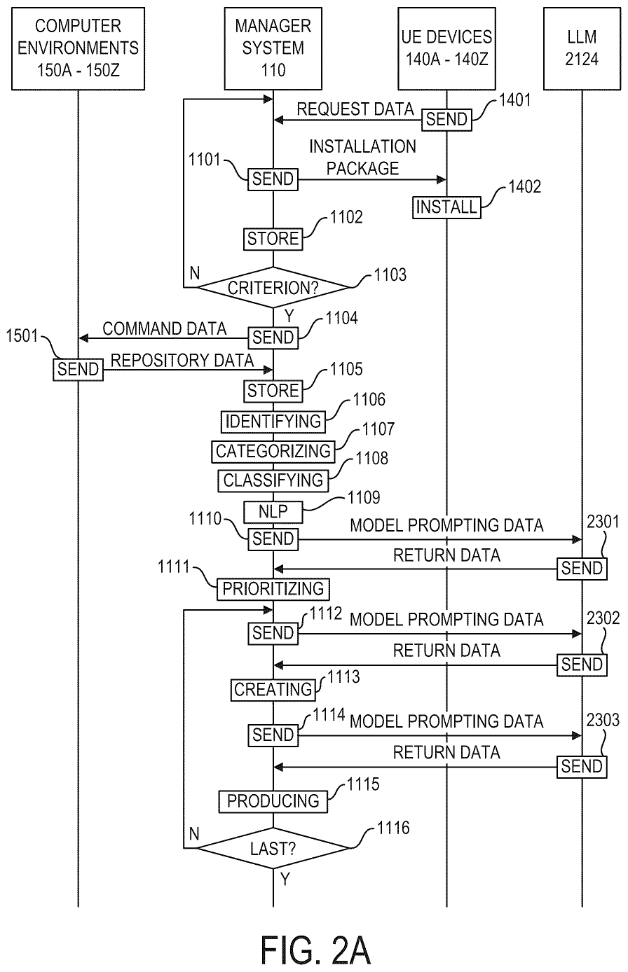

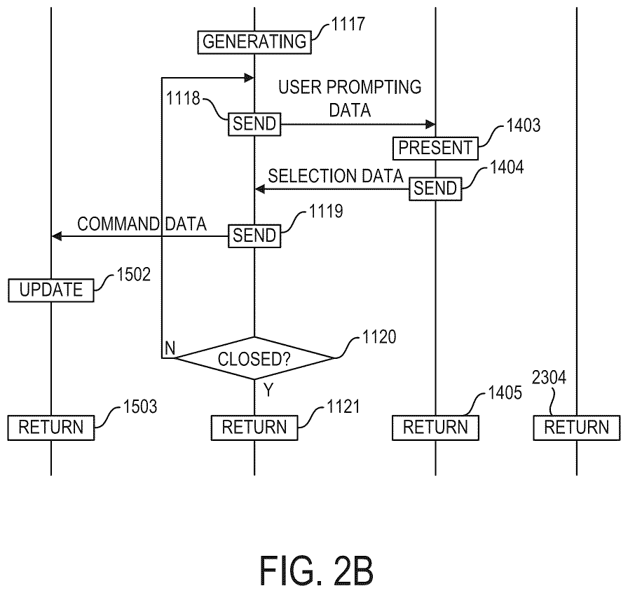

A method for performance by manager system 110 interoperating with computer environments 150A-150Z, UE devices 140A-140Z, one or more LLM stored in LLM area 2124 described in reference to the flowchart of FIG. 2.

At block 1401, UE devices 140A-140Z can be sending user-defined request data received by manager system 110. The request data sent at block 1401 can include request data defining a request to register as a registered user into system 100.

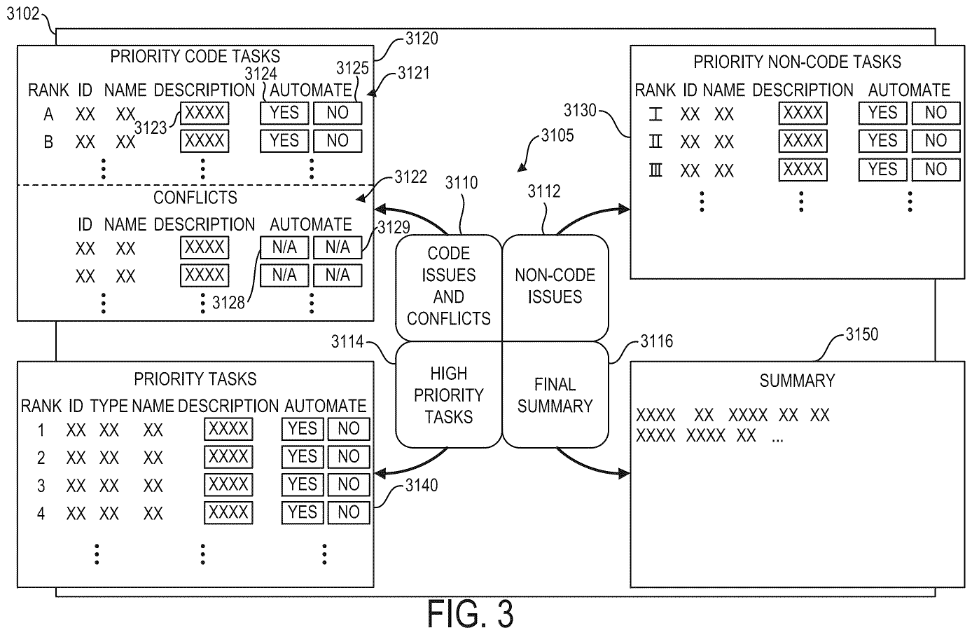

On receipt of the request data, manager system 110 at send block 1101 can send an installation package for receipt by UE devices of the UE devices 140A-140Z associated to instances of request data sent at send block 1401. On receipt of the installation package sent at send block 1101, respective UE devices of UE devices 140A-140Z receiving an installation package can install received the installation package at install block 1402. The installation package installed at install block 1402 can include an installation package that adapts a user associated UE device for operation in system 100. The installation package installed at install block 1402 can include an installation package that causes user interface 3102 as shown in FIG. 3 to be presented.

With the request data sent at block 1401, user associated UE devices sending the request data can send registration data. The registration data can specify, e.g., software project repositories that are associated to the user that initiated an instance of the request data. On completion of send block 1101, manager system 110 can proceed to store block 1102. At store block 1102, manager system 110 can store received registration data sent at block 1401 into user registry 2121 and can assign a UUID to each newly registered user of system 100. Registration data in one embodiment can include permission data. Permission data in one embodiment can define a permission that permits manager system 110 to scan a UE device of a newly registered user in order to discover all repositories associated to the newly registered user. Permission data in one embodiment can define a permission that permits manager system 110 to scan software project repositories to which the user is associated.

Within user registry 2121, there can be associated to each user a UUID and a list of repositories associated to each user, and locations, e.g., uniform resource locators (URLs) associated to each repository associated to each user. In one example, a certain user can have rights in and can be associated multiple software project repositories, e.g., a first “regular business/product” repository, a second repository for stretch assignments, a third repository for project and/or people management, and a fourth repository for upskilling and training.

On completion of store block 1102, manager system 110 can proceed to criterion block 1103. At criterion block 1103, manager system 110 can ascertain whether a criterion for generating user prompting data for a certain user of system 100 has been satisfied. Manager system 110 at various times can generate user prompting data that prompts a user to take action with respect to one or more repository of a user. The criterion of criterion block 1103 can include a criterion, e.g., current time matches a scheduled time period for generating user prompting data. Each registered user can configure a schedule for delivery of user interface prompting data with user of registration data included in request data sent at send block 1401.

In one example, manager system 110 can be configured to generate the prompting data at specified times, e.g., once daily, once weekly, once hourly, or the like. According to another example of a criterion at criterion block 1103, a criterion at criterion block 1103 can additionally or alternatively be a criterion that a predetermined action by user has been satisfied. The predetermined action can be, e.g., that a user has logged on to a UE device of the user, that a user has opened an application triggering satisfaction of criterion block 1103 (e.g., an application installed as a result of sending of the installation package at block 1101 and causing the user interface 3102 of FIG. 3 to be presented), that a certain window has been opened, that a message has been received from one or more collaborator, and the like. The criterion can be configurable by a user.

For a time that criterion block 1103 has not been satisfied, manager system 110 can return to a stage prior to block 1101 and can iteratively perform the loop of blocks 1101 to 1103 until a time that criterion block 1103 is satisfied. When criterion block 1103 is satisfied, manager system 110 can proceed to send block 1104.

At send block 1104, manager system 110 can send command data to computer environments 150A-150Z. Command data sent at send block 1104 can include repository data pull command data commanding computer environments 150A to 150Z to return repository data. On receipt of the command data sent at block 1104, computer environments 150A-150Z can send repository data, e.g., repository metadata.

To pull repository metadata, manager system 110 can employ a combination of Git commands, platform-specific APIs (like GitHub, GitLab, or Bitbucket), or automation tools. Commit metadata can be retrieved using commands like git log to view commit history (hash, author, date, message) and git show for file changes in a specific commit. Alternatively, the GitHub API (/commits) can fetch detailed commit information for the repository. Pull request (PR) metadata is accessible through APIs like GitHub's/pulls endpoint or GitLab's/merge requests endpoint, which provide details such as the PR title, description, branches involved, status, timestamps, and associated files or commits. Manager system 110 can also view PRs manually on platform web interfaces. Issue metadata, including the title, description, author, labels, assignees, status, and comments, can be obtained from APIs (/issues endpoint) or the repository's issue tracking interface. Branch metadata, such as branch names, latest commits, and status, is retrievable using Git commands (git branch, git log) or APIs (/branches endpoint). Test status metadata, which includes results of CI/CD tests (e.g., pass/fail, execution time, logs), is generally integrated into platforms' pipelines and accessible through their CI APIs. Combining these tools provides detailed insights into all repository activities and metadata, enabling efficient project management. Manager system 110 can restrict repository metadata collection to focus on a specific user by applying filters or queries via Git commands, platform APIs (like GitHub, GitLab, or Bitbucket), or custom scripts. For commit metadata, Git allows filtering using the --author flag in commands like git log, which retrieves only the commits authored by a particular user, or APIs like GitHub's/commits, where the author query parameter can isolate the user's contributions. Pull Request (PR) metadata can be filtered to show PRs created by or assigned to a specific user. This can be done through APIs such as GitHub's/pulls endpoint combined with author:username or assignee:username in the query, or directly in platform UIs with search filters. Similarly, issue metadata can be restricted to issues authored or assigned to a user using APIs (/issues) or search filters in the repository's issue tracker. For branch metadata, while Git does not inherently associate branches with users, contributions can be traced by reviewing branches with commits authored by the user using git log --author. Test status metadata, often linked to commits or PRs, can also be narrowed down by identifying tests associated with the user's commits or PRs, and querying CI/CD platforms' APIs for specific runs. Automating this process can involve scripting to integrate Git commands and API calls, dynamically filtering data based on user identifiers like name, email, or username. By combining these tools and methods, repositories can provide detailed user-specific insights into commits, PRs, issues, branches, and test results, ensuring targeted analysis or auditing of contributions while maintaining precision and accuracy.

In one aspect, for economizing of computing resources, the repository data pull command data sent at send block 1104 can be configured so that return data is specific to one user, i.e., the user associated to triggering criterion of criterion block 1104. Performing such processing reduces the processing load of manager system 110. In one aspect, for economizing of computing resources, the repository data pull command data sent at send block 1104 can be configured to selectively return metadata from a restricted time window, e.g. as of the time of a last task performed by a user. Metadata in a repository is timestamped to track events, and filtering it by a specific timestamp range can be done using repository tools or APIs. Commits include an author and committer timestamp, allowing filtering via Git commands like git log --since=“YYYY-MM-DD” --until=“YYYY-MM-DD”. Pull requests have created, updated, and merged timestamps, and APIs like GitHub's allow querying with parameters like since=YYYY-MM-DDTHH:MM:SSZ. Issues are timestamped with creation, update, and close events, similarly filterable via repository APIs. Branches don't store explicit timestamps but can be filtered by the last commit timestamp using git for-each-ref. Test status metadata (e.g., CI/CD pipelines) includes start, end, and update timestamps and can be queried through platform-specific APIs like GitHub Actions or Jenkins. To restrict data to a time range, Git commands and APIs provide robust options, with filters applied on timestamp fields in ISO 8601 format for consistency. Tools like GraphQL, REST APIs, or Git itself help retrieve and paginate large datasets. External tools can automate metadata queries for streamlined access.

For pulling repository metadata, according to one embodiment, manager system 110 at send block 1104 can send API calls to multiple API endpoints of each software project repository associated to the user triggering the criterion of criterion block 1103. The multiple API endpoints can define different metadata data sources.

```
TABLE A
Manager system 110 can pull the metadata in multiple ways. Manager system 110 can use any open-
source workspace management package, or any libraries or github API's.
Manager system 110 can pull data using github APIs as follows.
Get Commit Data: Endpoint: GET /repos/{owner}/{repo}/commits
Example:
curl -H “Authorization: token YOUR_TOKEN” \
  htt**ps:[[**]]api.github.com/repos/OWNER/REPO/commits
Get Pull Request Metadata: Endpoint: GET /repos/{owner}/{repo}/pulls
Example:
curl -H “Authorization: token YOUR_TOKEN” \
  htt**ps:[**]api.github.com/repos/OWNER/REPO/pulls
Get Issue Metadata: Endpoint: GET /repos/{owner}/{repo}/issues
Example:
curl -H “Authorization: token YOUR_TOKEN” \
  htt**ps:[**]api.github.com/repos/OWNER/REPO/issues
Get Branch Data: Endpoint: GET /repos/{owner}/{repo}/branches
Example:
curl -H “Authorization: token YOUR_TOKEN” \
  htt**ps:[**api.github.com/repos/OWNER/REPO/branches
Get Test Status (via CI/CD integrations): Use GitHub Actions API:
Endpoint: GET /repos/{owner}/{repo}/actions/runs
```

Pulled repository data can include various types of repository data of respective ones of software project repositories of the user associated to the triggering criterion of criterion block 1103. Repository metadata can include various types that provide detailed information about different aspects of a repository. Commit metadata captures details about individual commits, including the commit hash, author, committer, date, message, files changed, and parent commits, enabling precise tracking of changes. Pull request (PR) metadata describes proposed changes before merging, including the PR title, description, author, source and target branches, status (open, closed, merged), timestamps (creation, updates, merging), reviews, approvals, linked issues, and files/commits included in the PR. Issue metadata tracks tasks, bugs, or feature requests, detailing the issue title, description, author, status (open, in-progress, closed), labels, assignees, linked pull requests, timestamps, and comments for collaborative discussions. Branch metadata provides insights into repository branches, including their names, last commit (hash, author, date), parent branch, status (active, merged, deleted), associated PRs, and any branch protection rules (e.g., requiring reviews or CI checks). Lastly, test status metadata tracks the outcomes of automated or manual tests, capturing the test name/ID, result (pass, fail, skipped), type (unit, integration, end-to-end), execution time, associated commit or PR, logs, reports, and timestamps for test runs. Together, these metadata types help manage repositories effectively by providing transparency, traceability, and structure to code changes, collaborations, testing, and the overall lifecycle of the project.

The repository data sent at send block 1501 can include text specifying activity in respect to repositories associated to the user triggering satisfaction of a most recent iteration of criterion block 1103. On receipt of the repository data sent at block 1501, manager system 110 can store the repository data at store block 1105. The repository data stored at block 1105 can be stored into repository data registry 2122 of data store 108.

On completion of store block 1105, manager system 110 can proceed to identifying block 1106. At identifying block 1106, manager system 110 can identify tasks for completion by the certain user triggering satisfaction of the criterion block 1103. To analyze repository metadata and identify tasks for a specific user, manager system 110 can filter, organize, and interpret data across multiple sources like issues, pull requests (PRs), commits, branches, and test results. Manager system 110 can perform analyzing issue metadata to find open or in-progress issues assigned to the user, prioritizing based on urgency, labels (e.g., bug or enhancement), or deadlines. Use APIs or GitHub's interface to pinpoint tasks the user needs to address. Next, examine PR metadata to identify open PRs authored by or assigned to the user, focusing on those with unresolved review comments, failing tests, or awaiting merging. For commit metadata, track recent contributions using commands like git log --author, looking for incomplete work or commits tied to unresolved issues. Analyze branch metadata to identify active or stale feature branches owned by the user that require merging, rebasing, or further development. Additionally, use test status metadata from CI/CD tools to identify failed tests related to the user's contributions, highlighting debugging tasks or required reruns. Automating this process through scripts and APIs can aggregate relevant metadata, filter it by the user, and output a prioritized task list organized by urgency, type, and status. This approach ensures an efficient, user-specific workflow tailored to their responsibilities.

Manager system 110 can identify a wide range of tasks for completion by a user at identifying block 1106. Users interact with repositories through tasks that span development, collaboration, and maintenance. Code management involves cloning, pulling, pushing changes, branching, merging, and tagging for releases. Collaboration includes creating and assigning issues, commenting on code or discussions, reviewing pull requests, and resolving merge conflicts. On the development side, users write code, run tests, debug issues, and update documentation. For repository maintenance, users manage branches, configure CI/CD pipelines, version releases, and clean up unused files or dependencies. Administrative tasks include configuring repository settings, managing access and permissions, auditing activity logs, and integrating third-party tools like issue trackers or test runners. These tasks ensure the repository remains functional, secure, and organized, fostering collaboration and efficient development workflows.

At categorization block 1107, manager system 110 can categorize an identified task of the current certain user as being a code issue task or a non-code issue task. In one embodiment, manager system 110 can return the categorization of code task where repository data of the task is associated to a pull request (PR) of the certain user associated to the triggering criterion of criterion block 1103. Manager system 110 can return the categorization of non-code task in the case that the identified task of the certain user is not a pull request (PR) of the certain user. On completion of categorizing block 1107, manager system 110 can have categorized a first set of zero or more identified tasks as being code tasks for the user and a second set of zero or more code tasks of the user as being non-code tasks of the user.

Embodiments herein can include features for preventing failure of active codebase code and features for improved performance of active codebase code. In one aspect, embodiments herein can include features for restricting the incorporation of failure inducing code into a codebase. In a human in the loop aspect, embodiments herein can include features for automated updating of a codebase, conditional on a check for a code conflict. A user can be presented with controls for automated updating of a codebase with computer system protections being active which restrict the presentment of such controls in that case that a code task presents a conflict with a codebase.

At classifying block 110, manager system 110 can assign the classification of “code conflict” or “no conflict” to identified code tasks. For performance of such classification, manager system 110 can parse code associated to a PR code task of the user triggering the criterion at criterion block 1103 and can apply the following rules as are summarized in Table B. Code issues can comprise issues that are associated with a Pull Request. Embodiments herein can avoid generating a script to approve or merge the PR if there is a code conflict. Code conflicts can cause the main branch to be unstable. Manager system 110 can apply rules for determining a code conflict as set forth in Table B.

TABLE B
i) Manager system 110 can confirm that the same DATE master branch (base source code) has been
cloned from + same VERSION. Manager system 110 can check to assure that the branch subject to
merging has pulled the latest changes from main. Manager system 110 can determine that if the cloned
branch where the changes are being made is an older version of the main branch then that would lead to
code conflict.
ii) Manager system 110 can check to determine if any user updating a same portion of interest
determined +− x LOC(Lines of Code) (5% of local LOC): Manager system 110 can assure that some
other developer is not working on the same portion of LOC(lines of code). Manager system 110 can be
configured so that if there is a line threshold satisfying conflict (5% or greater conflict) in the lines of
code that a current developer user and a second developer user are working on, manager system 110
can register a code conflict and can prompt creation of prompting data prompting the developer user to
collaborate with the second developer user and make sure there is not a conflict. Metadata for
examination can be present in the commit history and such metadata can also specify what lines are
changed. Same interest of code herein refers to the changes that are present in the Pull Request (those
lines of code that are subject to merging).
iii) Manager system 110 can determine whether there are already existing PRs (merge code requests)
with same portion of interest: if there is already a Pull Request present for the same portion of code
manager system 110 can determine that there is a code conflict.
iv) Manager system 110 can determine whether there are Unit Test Cases failing with the current
developer user associated to the current identified task. If there are test cases failing then manager
system 110 can restrict a merge.
v) Manager system 110 can determine whether independent module x has a test case failed from some
developer y. If changes made by some other developer has test cases failing then manager system 110
can restrict a merge
vi) Manager system 110 can determine whether dependent PRs have a regression issue. Manager
system 110 on detection of a regression issue can delay the code merge. If there is a regression issue
(issues after code change) with a dependent PR, manager system 110 can delay the code merge.

In the case that manager system 110 detects a code issue at categorizing block 1107 and detects at classifying block 1108 that there exists a code conflict defined by merge conflict (decided by the rules discussed above in connection with Table B) manager system 110 for protection of a computer system hosting active codebase code can be restricted from producing user activatable code, e.g., a Selenium script for auto completion of a user task. Manager system 110 nevertheless can perform prioritizing of the identified code task for which a code conflict was detected, and create a summary of the identified code task for display in the dashboard, e.g., as defined by user interface 3102.

By reference to analyzing code changes herein it is meant that there is an analysis of changes that are present in a Pull Request. Embodiments herein recognize that a pull request has the part of the code that has been being changed so that other developers can review it and approve it. Embodiments herein can prompt an LLM to analyze these changes to provide a summary and also to determine if there is a code conflict (as set forth herein these changes along with all details like branch, commits are present in the metadata of the PR).

In reference to Table B, manager system 110 can check for code conflicts defined by discrepancies, regression issues, and/or failing unit tests, safeguarding the main codebase against potential errors and maintaining high standards of code quality.

As set forth further herein, manager system 110 can produce web automated script for completion of tasks on determining that there is no code conflict but can restrict the production of such web automated script when there is a code conflict. Thus, updates to a codebase can expedited in a manner that a computer system is protected from the incorporation of faulty code into a codebase.

On completion of classifying block 1108, manager system 110 can proceed to NLP block 1109. At NLP block 1106, manager system 110 can run NLP process 115. At NLP block 1109, manager system 110 can subject repository data associated to identified tasks to natural language processing from return of sentiment and/or subjectivity parameter values. The repository data subject to natural language processing can include comment data defined by comments associated to pull requests (PRs) which PRs as well as comments associated to other tasks. Text based User comments in repository metadata vary by context but are vital for collaboration and traceability. Commits include comments as commit messages, where users describe changes, and may have related feedback from code reviews in pull requests. Pull requests feature rich comments, including the initial description, inline review comments on specific code lines, general discussion threads. The activity log also records system-generated comments, such as approvals or requests for changes. Issues involve user comments in the initial description and follow-ups in discussions, often including bug reports, clarifications, or proposed solutions, along with reactions and auto-generated system notes (e.g., linking a pull request). Branches don't have direct user comments as metadata, but their purpose is often implied by naming conventions (e.g., feature/add-login), and comments on related commits or pull requests provide additional context. Test status metadata may include comments in build logs or inline annotations from CI/CD tools (e.g., GitHub Actions) that highlight test failures or coverage gaps. Discussions about test outcomes often occur in pull requests or issues, with users commenting on fixes or next steps. Overall, pull requests and issues are the most collaborative spaces for user comments, while commit messages and test logs provide context and traceability.

In regard to NLP block 1109, embodiments herein recognize that High Subjectivity+Negative Polarity can indicate a strongly negative opinion, that Low Subjectivity+Negative Polarity can indicate a fact-based negative statement, and that Low Subjectivity+Neutral Polarity can indicate a factual statement without emotion.

On completion of NLP block 1109, manager system 110 can proceed to send block 1110. At send block 1110, manager system 110 can send model prompting data for receipt by one or more LLM stored in LLM area 2124.

At send block 1110, manager system 110 can input a structured prompt into an LLM of LLM of LLM area 2124 for return of a prioritization score. The text based structured prompt can include (a) template text that repeats through instances of the structured prompt, (b) variable text extracted in dependence on repository data, e.g., extracted comments from repository metadata (c) one or more NLP parameter value output from NLP block 1109, (d) a request to output a prioritization score, and (e) one or more scoring criterion for assigning a prioritization score. The extracted variable text can be parsed and presented unmodified from the text based repository data and/or can be provided based on processing of the text based repository data, e.g., semantic meaning processing can be employed wherein longer text strings are processed for producing shorter semantic meaning text strings. The variable text can be output from processing of text based metadata of the data source (e.g. API data source set forth in Table A) from the preceding pull request that resulted in the current task being identified at identifying block 1106.

A structured prompt for prompting an LLM to return a prioritization score is set forth in Table C.

```
TABLE C
You are an AI assistant prioritizing tasks for a developer based on the following data. Assign a priority
score between 1 (low priority) and 10 (highest priority) based on urgency, severity, user sentiment, and
the analysis of comments on issues or pull requests.
Task Metadata:
- Title: “Fix critical login bug”
- Description: “Users are unable to log in after the latest update. Affected users are reporting this as a
blocker for their workflow.”
- Severity: “Critical”
- Tags: [“bug”, “blocker”, “backend”]
- Polarity and Subjectivity scores: XXXX (helps the LLM capture the context of the issue)
- Comments: The comments on this issue include statements such as:
  - “This is a showstopper for my team.”
  - “Users are furious about this bug; we need to prioritize it now.”
  - “Multiple users have reported that this is blocking them from accessing core features.”
Scoring Factors:
1. Higher severity (e.g., “Critical” or “Blocker”) increases priority.
2. Frustrated or urgent user sentiment in the description and comments increases priority.
3. Tasks tagged with “bug” or “blocker” have higher weight.
4. The number and tone of comments can increase priority, particularly if the issue impacts multiple
users or teams.
5. Time sensitivity or widespread impact further increases priority.
6. Increased subjectivity increases priority
Output Format:
1. Provide a priority score (1-10).
2. Briefly explain the reasoning for the score, including any relevant details from the comments.
Now, calculate the priority score for this task.
You are an AI assistant prioritizing tasks for a developer based on the following data. Assign a priority
score between 1 (low priority) and 10 (highest priority) based on urgency, severity, user sentiment, and
the analysis of comments on issues or pull requests.
Task Metadata:
- Title: “Fix critical login bug”
- Description: “Users are unable to log in after the latest update. Affected users are reporting this as a
blocker for their workflow.”
- Severity: “Critical”
- Tags: [“bug”, “blocker”, “backend”]
- Sentiment Analysis: Negative (comments indicate frustration and urgency).
- Comments Analysis: The comments on this issue include statements such as:
  - “This is a showstopper for my team.”
  - “Users are furious about this bug; we need to prioritize it now.”
  - “Multiple users have reported that this is blocking them from accessing core features.”
Scoring Factors:
1. Higher severity (e.g., “Critical” or “Blocker”) increases priority.
2. Frustrated or urgent user sentiment in the description and comments increases priority.
3. Tasks tagged with “bug” or “blocker” have higher weight.
4. The number and tone of comments can increase priority, particularly if the issue impacts multiple
users or teams.
5. Time sensitivity or widespread impact further increases priority.
Output Format:
1. Provide a priority score (1-10).
2. Briefly explain the reasoning for the score, including any relevant details from the comments.
```

The text based structured prompt of Table C can include (a) template text that repeats through instances of the structured prompt (“Title”, “Description” . . . ), (b) variable text (“Fix critical login bug”, “Users are unable . . . ”, “This is a showstopper . . . ”) extracted in dependence on repository data, e.g., extracted comments of other data from repository metadata, (c) one or more NLP parameter value output from NLP block 1109, (d) a request to output a prioritization score, and (e) one or more scoring criterion (factors 1-6) for assigning a prioritization score. The template text can include the text (e.g., “provide a priority score”) defining the request to output a prioritization score.

At send block 1110, manager system 110 can present a structured prompt in the manner of depicted in Table C for all identified current tasks associated to the current user. In response to being prompted as set forth in Table C the prompted LLM can send return data at send block 2301 for receipt by manager system 110. Manager system 110 can store the return data into session registry 2123 and can proceed to prioritizing block 1111. At prioritizing block 1111, manager system 110 can prioritize all tasks based on the return data returned prioritization score for each task. Manager system 110 at block 1111 can output a ranked order lists of all tasks based on the prioritization scores returned at send block 2301.

On completion of prioritizing block 1111, manager system 110 can proceed to send block 1112 for creation of a summary of a task. At send block 1112, manager system 110 can send an LLM of LLM area 2124 a structured prompt configured to return output of a text based summary of a task, wherein the structured prompt can comprise variable data dependent on repository data of a task and request data requesting the LLM to provide a summary the task. As noted in respect to categorizing block 1107, tasks can be categorized as code or non-code tasks.

Prompting data for prompting an LLM to create a summary of a non-code task can include prompting data structured as set forth in Table D.

TABLE D
(structured prompt for output of non-code task summary)

```
You are an AI assistant helping to summarize high-priority tasks for developers. Analyze the following
issue/PR metadata and comments, then generate a concise summary that captures the core problem or
task and its urgency.
Task Metadata:
- Title: “Fix critical login bug”
- Description: “Users are unable to log in after the latest update. Affected users are reporting this as a
blocker for their workflow.”
- Severity: “Critical”
- Tags: [“bug”, “blocker”, “backend”]
- Polarity and subjectivity scores: XXXX
- Comments:
  - “This is a showstopper for my team.”
  - “Users are furious about this bug; we need to prioritize it now.”
  - “Multiple users have reported that this is blocking them from accessing core features.”
Output Format:
1. Provide a concise summary of the issue/PR.
2. Highlight its urgency, severity, and impact.
Now, summarize this issue.
```

Prompting data for prompting an LLM to create a summary of a code task can include prompting data structured as set forth in Table E.

TABLE E
(structured prompt for output of code task summary)

```
You are an AI assistant helping to summarize high-priority tasks for developers. Analyze the following
PR metadata and comments, then generate a concise summary that captures the core problem or task
and its urgency.
Task Metadata:
- Title: “Fix critical bug in user authentication”
- Description: “A bug in the user authentication code is preventing users from logging in after the latest
update. The issue is affecting all users trying to authenticate, and it's a blocker for access to core
features.”
- Severity: “Critical”
- Tags: [“bug”, “blocker”, “authentication”, “backend”]
- Code Changes: (Include summary of code changes, such as function updates, fixes, or new logic
implemented from PR metadata)
- Polarity and Subjectivity Scores: XXXX
- Comments:
  - “This bug is a showstopper for user access, needs immediate attention.”
  - “The login functionality is broken, and this has impacted all users trying to access the system.”
  - “Several users have reported they can't access their accounts; this PR must be prioritized.”
Output Format:
1. Provide a concise summary of the PR, including a brief description of the code changes and how
they aim to address the problem.
2. Highlight its urgency, severity, impact, and potential blockers in the system.
```

As noted in respect to Table D and E, the configuration of a structured prompt for return of a summary can depend on task type (non-code or code). In reference to Table D and E, a structured prompt for return of the task summary can include (a) template text that repeats through instances of the structured prompt (“Title”, “Description”, “Output format: . . . ”), (b) variable text extracted in dependence on repository data, e.g., extracted comments of other data from repository metadata, and (c) a request to output a summary. The template text can include the text defining the request to output a summary. The configuration of the template text can be differentiated between the structured prompt for prompting return of a non-code task summary and the structured prompt for prompting return of a code task summary, e.g., the structured prompt in the code task case can include the text “Provide a concise summary of the PR, including a brief description of the code changes” as set forth in Table E.

At send block 2302, the prompted LLM can send return data to manager system 110. On receipt of the return data, manager system 110 can receive the return data for a given task and for completing creation of summary data can store the received summary data into session registry 2123 at creating block 1113.

On completion of creating block 1113, manager system 110 can proceed to send block 1114 for producing web automated script for completion of a task. At send block 1114 manager system 110 can send an LLM of LLM area 2124 a structured prompt configured to return a web automation script for completion of a task, wherein the structured prompt comprises template text, variable data text based on repository data of a task and request data requesting the LLM to provide web automation script for completion of a task. As set forth in reference to categorizing block 1107, identified tasks can be categorized as code tasks or non-code tasks.

A structured prompt for prompting an LLM to produce web automated script in the case of a non-code task can include the prompting data structure as set forth in Table F.

TABLE F
(structured prompt for output of non-code task web automation code)

```
You are an AI assistant tasked with automating Git-based workflows using Selenium. Based on the
analyzed metadata and context, decide the most appropriate action to perform. Use the following steps:
1. Analyze the metadata to determine the required action (e.g., “comment” or “close issue”).
2. Based on the decision, generate a Python Selenium script for the chosen action. Ensure the script is
clear, functional, and modular.
Metadata:
- Title: “Fix critical login bug”
- Description: “Users are unable to log in after the latest update. Affected users are reporting this as a
blocker for their workflow.”
- Severity: “Critical”
- Tags: [“bug”, “blocker”, “backend”]
- Polarity and Subjectivity scores: XXXX
- Comments:
  - “This is a showstopper for my team.”
  - “Users are furious about this bug; we need to prioritize it now.”
  - “Multiple users have reported that this is blocking them from accessing core features.”
- Action Type (to Decide): Dynamically decide the action based on the metadata (e.g., comment on the
issue to provide reassurance, close the issue if resolved).
- Target URL: htt**ps:[**]github.com/example-repo/issues/12345
- Additional Input:
  - If the action is “comment”, provide: “We are actively working on resolving this issue and will
provide updates soon.”
  - If the action is “close issue”, no additional input is required.
- Context: “This issue is critical and marked as a blocker. Users are frustrated, and quick action is
required.”
Scenarios to Handle:
1. Commenting on an Issue:
  - If the metadata suggests that reassurance is needed, generate a script to add a comment.
2. Closing an Issue:
  - If the metadata or context indicates the issue has been resolved, generate a script to close the issue.
Output Format:
1. Decide the appropriate action.
2. Provide a complete Python Selenium script for the selected action.
3. Ensure the script is modular and adaptable for similar tasks in the future.
Now, analyze the metadata and generate the required script.
```

A structured prompt for prompting an LLM to produce web automated script in the case of a code task can include the prompting data structure as set forth in Table G.

TABLE G
(structured prompt for output of code task web automated script)

```
You are an AI assistant tasked with automating Git-based workflows using Selenium. Based on the
analyzed metadata and context, decide the most appropriate action to perform. Use the following steps:
1. Analyze the metadata and code changes to determine the required action (e.g., “comment” or
“approve PR” or “it's a merge conflict”).
2. Based on the decision, generate a Python Selenium script for the chosen action. Ensure the script is
clear, functional, and modular.
Task Metadata:
- Title: “Fix critical bug in user authentication”
- Description: “A bug in the user authentication code is preventing users from logging in after the latest
update.”
- Severity: “Critical”
- Tags: [“bug”, “blocker”, “authentication”, “backend”]
- Code Changes (PR metadata): XXXX
- Polarity and Subjectivity Scores: XXXX
- Comments:
  - “This is a showstopper for my team.”
  - “We need to prioritize this fix immediately!”
- Merge Conditions:
  - Base Source Code Date: (e.g., “2025-01-06”)
  - Base Version: (e.g., “v1.2.0”)
  - Commit history in other branches for the same LOC(if present)
  - PR for the same feature/ same LOC(if present this would be sent)
  - Unit Test Failures: from github
  - Failed Tests in Independent Modules
  - Regression Issues in Dependent PRs
```

As noted in respect to Table F and G, the configuration of a structured prompt for return of web automated script can depend on task type (non-code or code). In reference to Table F and G, a structured prompt for return of web automated script can include (a) template text that repeats through instances of the structured prompt (“Title”, “Description”, “Code Changes: . . . ”), (b) variable text extracted in dependence on repository data, e.g., extracted comments of other data from repository metadata, and (c) a request to output web automation script defining user activatable code for automated performance of the task. The template text can include the text defining the request to output a summary. The configuration of the template text can be differentiated between the structured prompt for prompting return of a non-code task summary and the structured prompt for prompting return of a code task summary, e.g., the structured prompt in the code task case can include the text “Merge Conditions” as set forth in Table E. The variable data associated with the “Code Changes” template text can be extracted by comparison of PR code to code of a codebase. To determine the changes proposed in a pull request (PR) relative to a codebase, manager system 110 can perform reviewing its metadata, including the source and target branches, title, description, and commit history, which provide context and purpose. Analyze the diff to identify modified, added, or deleted files, and examine line-by-line changes showing additions, deletions, or modifications. Context is key-evaluate the surrounding code to understand the impact and scope of the changes, such as dependencies or altered functionality. Check if tests have been added or updated to cover the changes and ensure no existing functionality breaks. Documentation updates, such as README files or inline comments, often explain the changes further. Automated tools like CI/CD pipelines, which run builds and tests, and static analysis tools, which detect code quality issues, are essential for identifying problems early. Combining metadata review, manual code inspection, and automated tools provides a comprehensive understanding of the proposed changes and their potential impact on the codebase.

At send block 2303, in response to being prompted with model prompting data sent at send block 1114, the prompted LLM can send return data to manager system 110. On receipt of the return data, manager system 110 for completing producing of web automation script for performance of a task (code or non-code task) can store the received web automation script into session registry 2123 at producing block 1115.

In one aspect, producing of user activatable code, e.g., web automated script as set forth in reference to send block 1114, send block 2303, and producing block 1115 can include producing web automated script for completion of a merge task. Once all feedback has been addressed and the PR is approved, the next step is merging. Merging integrates the proposed changes from the source branch into the target branch, making the updates available to others. The developer who created the PR might handle the merge if they have the required permissions and the workflow allows it. However, in larger teams or repositories, embodiments herein recognize that merging is often done by a reviewer or maintainer to ensure all quality checks are satisfied. PRs and merges work together as two steps in the same workflow: the PR serves as the discussion and review stage, while merging finalizes the process by incorporating the updates into the codebase. This structured process ensures that code changes are well-reviewed, properly tested, and meet project standards before becoming part of the shared repository, helping teams maintain code quality and reduce errors in collaborative environments.

In one aspect, the producing of web automated script for completion of a code task can be made conditional on the determination that code task does not raise any conflicts. Embodiments herein can include features for preventing failure of active codebase code and features for improved performance of active codebase code. In one aspect, embodiments herein can include features for restricting the incorporation of failure inducing code into a codebase. In a human in the loop aspect, embodiments herein can include features for automated updating of a codebase by production of web automated script, conditional on a check for a code conflict. A user can be presented with controls defined by user activatable web automated script for automated updating of a codebase with computer system protections being active which restrict the presentment of such controls in the case that a code task presents a conflict, e.g., with a codebase.

In one embodiment, the produced web automated script can be provided by Selenium script. A Selenium script can automate web browser interactions and can have several key attributes. It can use a WebDriver to control browsers like Chrome, Firefox, or Edge, enabling tasks such as navigating to URLs, interacting with web elements, and extracting data. The script can include locators (e.g., XPath, CSS selectors, or IDs) to identify elements on a webpage and can support actions like clicking, typing, or scrolling. It can handle dynamic content by using explicit or implicit waits to ensure elements load before interacting with them. Assertions can be included to validate functionality during testing. Selenium scripts can be written in various programming languages, such as Python, Java, or JavaScript, and can integrate with test frameworks like PyTest or JUnit for structured testing. They can also handle alerts, cookies, and file uploads/downloads. Selenium scripts can be used for testing, data extraction, or automating repetitive tasks in a browser environment.

On completion of producing block 1115, manager system 110 can proceed to decision block 1111. At decision block 1111, manager system 110 can ascertain whether summary data and/or web automation script has been output for the last identified user task identified at identifying block 1106. On the determination that there are remaining tasks for generation of summary data and/or web automation script, manager system 110 can return to a stage preceding send block 1112. Manager system 110 can iteratively perform the loop of block 1112-1116 until summary data and/or web automation script has been generated for a last identified task.

On determination at decision block 1116 that summary data and/or web automation script has been generated for a last identified task identified at block 1106 manager system 110 can proceed to generating block 1117. At generating block 1117, manager system 110 can generate prompting data for inclusion in a user interface for presentment to a user. Manager system 110 can store generated user prompting data into session registry 2123 at generating block 1117.

On completion of generating block 1117, manager system 110 can proceed to send block 1118. At send block 1118, manager system 110 can send user prompting data to the certain user as generated at generating block 1117. The sending of prompting data at send block 1118 can include presenting the generated prompting data in a user interface presented to the certain user. The UE device of the user can present the user interface at present block 1403. At send block 1118, manager system 110 can send user prompting data to the UE device of UE devices 140A-140Z associated to the user triggering satisfaction of the most recent iteration of criterion block 1103. On receipt of the user prompting data sent at send block 1118, the certain UE device of UE devices 140A at present block 1403 can present the generated user prompting data.

User interface 3102 for presentment to the certain user is set forth in reference to FIG. 3. User interface 3102 can summarize all current tasks identified for performance by the user triggering satisfaction of criterion block 1103, as identified at identifying block 1106. Main interface area 3105 can include a plurality of buttons including code issues and conflicts button 3110, non-code issues button 3112, high priority tasks button 3114, and final summary button 3116. The user can activate any one of the described buttons and in response, based on the generating at generating block 1117, additional prompting data can be presented to the user.

By activating code issues and conflicts button 3110, the user can be presented window 3120. In window 3120 there can be presented a priority code tasks area 3121 and the conflicts area 3122. In priority code tasks area 3121, there can be presented a text based list of code tasks. Each code task can be presented with a row of presented data in a ranked ordered list as determined by running of prioritizing process 116 and as described in connection with blocks 1109 to 1111.

In conflicts area 3122, there can be presented a list of identified code conflicts as identified with use in connection with classifying block 1108. For each task presented in priority code tasks area 3121, there can be a prioritization ranking, an ID, a name for the task, a description of the task, and automate selection buttons. The user can activate description button 3123 to obtain additional summary description of the task. When a user activates YES automate button 3124, web automation script produced as described at blocks 1114 to 1115 can be executed. When a user activates NO button 3125 a manual process can be carried out by the user to address complete the task. Regarding “automate” buttons formatted as described in connection with “automate buttons” 3124 and 3125, manager system 110 in configurating the custom configured user interface 3102 can disable “automate” buttons in the case that a code conflict was detected for the relevant code task at classifying block 1108. For example, in code task conflicts area 3122 the “automate” buttons 3128 and 3129 are restricted, disabled and made not applicable (N/A) for activation. As noted, where a code conflict is detected, manager system 110 for protection of a computer system hosting active codebase code can selectively avoid the production of web automated script for completion of the code task, thus ensuring that fault code is not incorporated into active codebase code.

Remaining description and automate buttons set forth in reference to user interface 3102 can have the functionality as described in reference to buttons 3123 to 3125. In area 3122 “automate” buttons 3128 and 3129 can be restricted, disabled and made not applicable (N/A) for activation where a displayed row is associated to a code task for which a code conflict was detected at classifying block 1108.

When a user activates non-code issues button 3112, window 3130 can appear on user interface 3102 which presents a text-based prioritized listing of non-code tasks. Manager system 110 can distinguish code tasks and non-code tasks in the manner described in reference to categorizing block 1107. In reference to window 3130, the user can be presented a ranked ordered list of non-code tasks arranged in the priority order as discovered by execution of blocks 1109 to 1112.

Using the “description” and “automate” buttons set forth in reference to window 3130, a user can elect to obtain more summary information of the task, or can activate web automation script produced as described in connection with blocks 1114 to 1115, or can select addressing the task via manual action.

When a user activates high priority tasks button 3114, a user can be presented window 3140 which presents a listing a priority tasks. In window 3140 there can be presented blended listing of tasks, i.e., including both code tasks and non-code tasks as have been discovered using categorizing block 1107. Each task can be presented in a text-based row as depicted in window 3140. For each task, there can be presented a prioritized ranking as determined by performance of blocks 1109-1111 for performing prioritizing, an ID for the task, the type of task, i.e., code or non-code, the name of the task, description of the task, and automate selection buttons as set forth in reference to windows 3120 and 3130. The user can elect by activation of a “description” button additional summary data for the task, can select and automate YES button for activating web automation script for performance of the task, or can activate a manual activate button for electing to address the task by manual action.

When a user activates final summary button 3116, a user can be presented summary window 3150. Summary window 3150 can include a summary explanation overview of all tasks open for performance by the user.

On completion of present block 1403, the certain UE device of UE devices 140A-140Z can proceed to send block 1104. At send block 1104, the certain UE device of UE devices 140A-140Z can send selection data for receipt by manager system 110. Based on receipt of the selection data sent at send block 1404, manager system 110 can proceed to send block 1119.

At send block 1119, manager system 110 can send command data to the relevant computer environments of computer environments 150A-150Z based on the selection data sent at block 1404. The relevant computer environments 150A-150Z on receipt of the command data sent at block 1119 can perform updating at update block 1502. Where web automation script has been selected using user interface 3102, the command data can include command data to run the web automation script. Updating at update block 1502 can include updating of active codebase code, e.g., core branch code to improve performance of an application or service, as well as to improve performance of the computer system hosting such application or service. Embodiments herein recognize that failure to manage updates to core branch code can result in diminished performance (including failure) of core branch code.

On completion of send block 1119, manager system 110 can proceed to “closed” decision block 1120. At “closed” decision block 1120, manager system 110 can ascertain by examination of selection data sent at the most recent iteration of send block 1404 whether a user has closed a current user interface session. On determining that the current user interface session has not been closed, manager system 110 can return to a stage preceding block 1118 so that at next iteration of send block 1118 manager system 110 can update user interface 3120 based on most recently received selection data. Manager system 110 can iteratively perform the loop of blocks 1118 and 1119 responsively to a sequence of selections of the user until a time that manager system 110 at “closed” decision block 1120 determines that a user has closed a current user interface session.

On completion of “closed” decision block 1120, manager system 110 can proceed to return block 1121. At return block 1121, manager system 110 can return to a stage preceding block 1101 to receive a next iteration of request data sent at block 1401. Manager system 110 can iteratively perform the loop of blocks 1101 to 1121 for a deployment period of manager system 110. It will be understood that manager system 110 can be running multiple instances of the loop of blocks 1101 to 1121 for multiple users (any one of whom may trigger satisfaction of criterion block 1103) of system 110 contemporaneously, concurrently, and simultaneously.

Computer environments 150A-150Z on completion of update block 1502 can proceed to return block 1503. At return block 1503, computer environments 150A-150Z can return to a stage preceding send block 1501 to receive a next iteration of command data sent at block 1104. Computer environments 150A-150Z can iteratively perform the loop of block 1501 to 1503 for a deployment of computer environments 150A-150Z.

On completion of send block 1404, UE devices 140A-140Z can proceed to return block 1405. On completion of return block 1405, UE devices 140A-140Z can return to a stage preceding send block 1401 to send a next iteration of request data as defined by users of UE devices 140A-140Z who wish to become registered users of system. UE devices 140A-140Z can iteratively perform the loop of blocks 1401 to block 1405 for a deployment period of UE devices 140A-140Z.

The one or more LLM of LLM area 2124 on completion of send block 2303 can proceed to return block 2304. At return block 2304, the one or more LLM of LLM area 2124 can return to a stage preceding block 2301 to receive a next iteration of model prompting data sent at block 1107. The one or more LLM of LLM area 2124 can iteratively perform the loop of blocks 2301 to 2304 for a deployment period of the one or more LLM of LLM area 2124.

In further reference to NLP block 1109, manager system 110 can perform natural language processing on repository data, e.g., comment data associated to a PR, for return of sentiment parameter values and subjectivity parameter values. Polarity refers to a float which lies in the range of [−1,1] where 1 means positive statement and −1 means a negative statement. Subjective sentences generally refer to personal opinion, emotion or judgment whereas objective refers to factual information. Subjectivity also refers to a float which lies in the range of [0,1]. Example Python code for return of sentiment and subjectivity parameter values is set forth in Table H.

```
TABLE H
from textblob import TextBlob
def analyze_pr_comment(comment_text):
  “““
  Analyze the sentiment and subjectivity of a given PR comment text.
  Args:
    comment_text (str): The PR comment text to analyze.
  Returns:
    dict: A dictionary with sentiment polarity and subjectivity scores.
  ”””
  # Create a TextBlob object
  blob = TextBlob(comment_text)
  # Compute sentiment polarity and subjectivity
  sentiment_score = blob.sentiment.polarity # Ranges from −1 (negative) to 1 (positive)
  subjectivity_score = blob.sentiment.subjectivity # Ranges from 0 (objective) to 1 (subjective)
  # Return results
  return {
    “sentiment”: sentiment_score,
    “subjectivity”: subjectivity_score
  }
# Example usage
if _{——}name_{——} == “_{——}main_{——}”:
  comment = “This is a fantastic implementation, but there might be a small bug in the edge case.”
  result = analyze_pr_comment(comment)
  print(f“Sentiment: {result[‘sentiment’]}”)
  print(f“Subjectivity: {result[‘subjectivity’]}”)
```

An example output resulting from execution of the code of Table H is shown in Table

TABLE I

Sentiment: 0.4
Subjectivity: 0.75

Embodiments herein recognize that computer systems can fail due to management responsibilities of users who can become overwhelmed with performance of tasks in relation to multiple software project repositories to which they have right. Embodiments herein recognize that quality assurance (QA) engineers, or DevOps professionals, face challenges in tracking updates, automating tasks, and navigating numerous dashboards. These tools require significant manual effort to view updates across several tabs, prioritize tasks, and complete repetitive tasks.

Embodiments herein recognize that this inefficiency becomes particularly evident over the course of a week, as users need to manually review contributions, comments, and status changes across various projects. Existing tools like Git Copilot leverage Gen AI to enhance their capabilities, but they do not offer a unified system that prioritizes tasks, automates them using AI-generated scripts, and consolidates all relevant information into a single dashboard.

Embodiments herein aim to address these pain points by developing a comprehensive system that provides a consolidated overview of all tasks, leverages generative AI for task automation, and prioritizes tasks based on a priority queue. Embodiments herein can fetch, organize, and display updates from multiple repositories in a bulletin board-like format, simplifying the user's workflow. Embodiments herein can handle automated notifications, status changes, and task completions based on user input or predefined criteria. By enhancing existing version control tools, embodiments herein can cater to the growing needs of modern software development processes, improving efficiency, and reducing manual labor.

Embodiments herein can integrate an open source workspace management tool to consolidate repositories, providing unified access to issues and pull requests (PRs) across multiple version control systems. Embodiments herein can optimize developer workflow by centralizing management and enhancing accessibility. Simultaneously, generative AI can be employed to prioritize issues autonomously. By analyzing issue content and leveraging metadata (such as labels, descriptions, severity, and deadlines), along with NLP-derived insights (polarity, subjectivity), the AI can efficiently ranks tasks.

In one aspect herein, NLP analysis data can enrich prompts to a large language model (LLM), aiding in comprehensive issue understanding even for models with varied training datasets. This dual approach ensures compatibility with any language model available, facilitating adaptable implementation across diverse software development environments.

Embodiments herein can integrate multiple functionalities to streamline software development and enhance efficiency. Utilizing version control metadata, embodiments herein can generate data captures of issues. The data capturing can be period, e.g., daily, and/or can be responsive to criterion other than a scheduling matching criterion. The capturing can include metadata capturing from multiple data sources via API calls. Data capturing features can empowers users to query and load data captures for targeted time windows, providing flexibility in managing and reviewing historical data.

Embodiments herein can provide automated task handling. Embodiments herein can provide tailored automation that distinguishes between code and non-code issues. For code-related tasks, manager system 110 can perform comprehensive checks. Manager system 110 can reviews pull request changes to ensure compatibility, detects and resolves merge conflicts, and can verify the absence of regression issues or failed unit tests. Manager system 110 responsively to confirming that a PR does not present a code conflict can product selenium script for automated actions such as merging PR code into a codebase. This meticulous approach ensures code integrity and minimizes errors in the main codebase. For non-code issues, manager system 110 can generate summaries and create selenium script for automated actions such as commenting on issues or approving PRs.

As noted embodiments herein can provide conditional code merge verification. Manager system 110 with use of backend logic can apply stringent conditions before merging code changes. Manager system 110 can check for code conflicts defined by discrepancies, regression issues, and/or failing unit tests, safeguarding the main codebase against potential errors and maintaining high standards of code quality.

Embodiments herein can leverage generative AI for task prioritization and automation. Embodiments herein can empower users to prioritize and automate trivial tasks efficiently through generative AI. AI can be employed to analyzes issue content and metadata, utilizing NLP-derived insights for accurate understanding and prioritization. Embodiments herein ensure effective handling of tasks, regardless of the complexity or training data variations in deployed models.

Users herein can benefit from a dashboard interface that presents prioritized tasks alongside summaries. Users can opt to auto-complete tasks in a prioritized sequence directly from the dashboard. Generated selenium scripts made available for activation on a user interface such as user interface 3102 can facilitate seamless execution of actions, thereby reducing manual effort, ensuring consistency, and enhancing overall productivity in software development workflows.

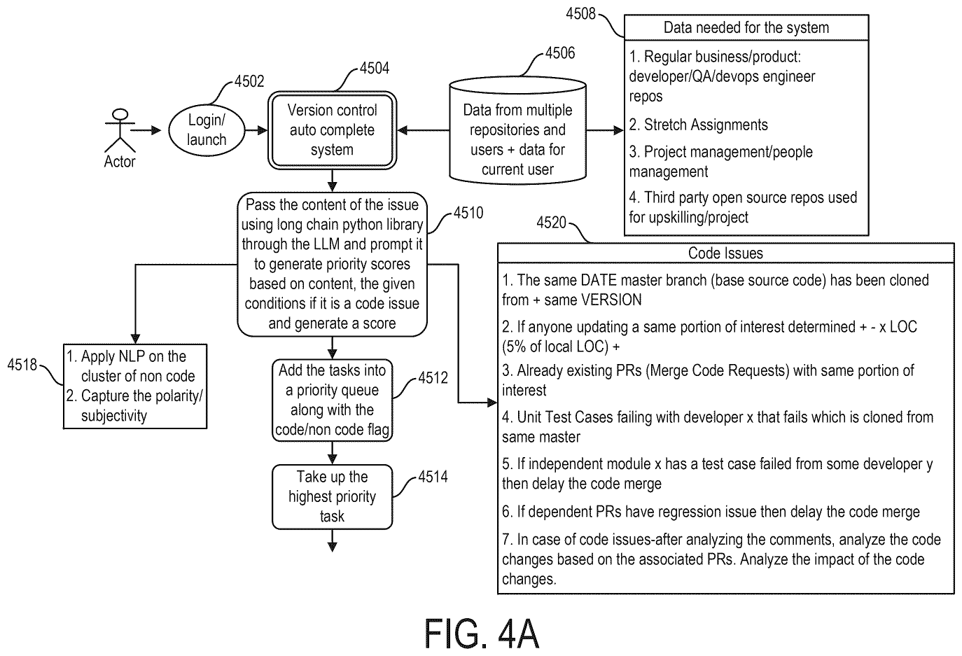

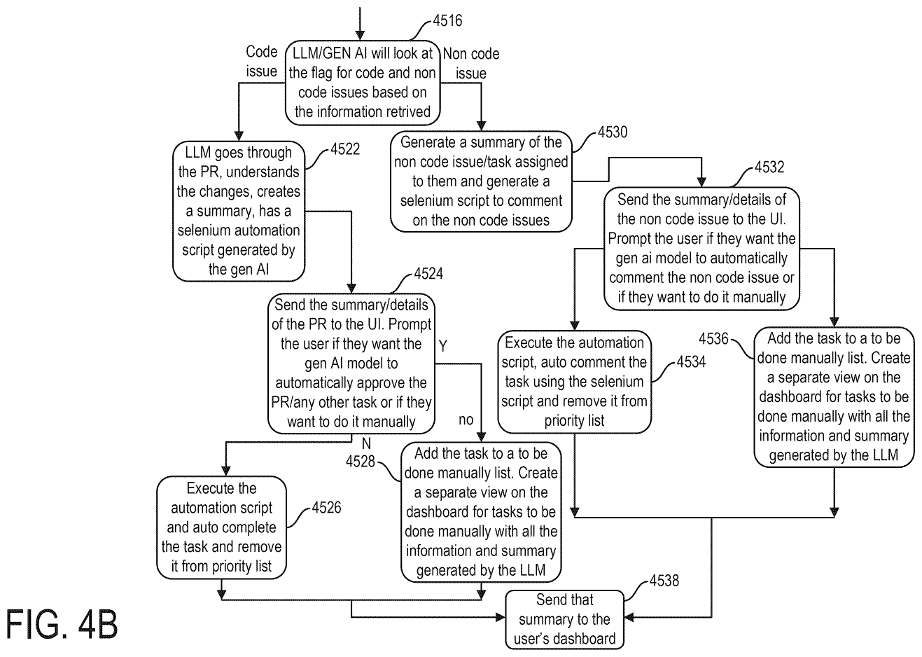

An example of system 100 performing a method according to the flowchart of FIG. 2A-2B is set forth in reference to FIG. 4A-4B. At block 4502, a user can log into system 100. System 100 can be implemented as an extension of a version control system as set forth in reference to block 4504. A user can have rights and can be associated to multiple repositories as set forth in reference to block 4508. System 100 can capture data from multiple repositories as set forth in reference to block 4506. As depicted in block 4510, manager system 110 can output priority scores with the use of an LLM. Prompting can be enhanced with use of natural language processing as set forth in reference to block 4518. As set forth in reference to block 4512, manager system 110 can add tasks to a priority queue along with a code/non-code flag. Manager system 110 as depicted in block 4514 can take up the highest priority task. As depicted in block 4516, manager system 110 can distinguish between code and non-code issues in dependence on raised flags as set forth in reference to block 4520. Manager system 110 can apply rules for identification of code conflicts. Code issues can be processed according to blocks 4522, 4524, 4526 and 4528. Non-code issues can be processed as set forth in reference to blocks 4530, 4532, 4534 and 4536. As depicted in block 4538, manager system 110 can send a summary of tasks to a user dashboard as defined by user interface 3102.

Embodiments herein recognize that it can be difficult for a team or an individual working on several software project repositories to acquire a summary of what has happened, or to exercise control overs such repositories in a manner that satisfactory performance of core branch code is maintained, leading to system failure. Embodiments herein can provide a universal dashboard defined by user interface 3102 that is in communication with multiple software project repositories. Embodiments herein can automate pertinent tasks over the course of a relevant time period and can examine multiple software project repositories to obtain relevant information.

Embodiments herein can provide a method that provides an overview of all tasks in the form of a single dashboard defined by user interface 3102 in communication with multiple software project repositories and provides an option of automating of those tasks with the help of generative artificial intelligence (AI) models. Embodiments herein can order tasks based on their priority using a priority queue and can generate web automation script for completion of tasks using generative AI.

Embodiments herein recognize that current version controller (VC) tools require a user to view several tabs and projects to exercise action in respect to repository and that user can be readily overloaded with manual tasks to implement views, approvals, code edits, comments and the like. Embodiments herein provide a comprehensive picture of all tasks and uses generative AI to automate tasks.

Embodiments herein recognize that version controller tools can find use with developers as well as additional individuals who are not developers. With the rapidly growing technical world, storage, documentation, reusability are the key aspects of a software development process today. Embodiments herein recognize that version controller tools can be of use to quality assurance (QA) engineers, DevOps engineers, for documentation, recording the events and the like.

Embodiments herein can enhance existing version control tool capabilities by equipping them to handle beyond version controlling. Embodiments herein can facilitate a user on compartmentalizing the users, TODOs, help the user prioritize tasks and even complete tasks.

Embodiments herein can provide notification on updates that have happened over the last configurable time periods, for users working on multiple repositories and multiple repositories being handled by multiple users. Embodiments herein can provide fetching, organizing and consolidating the information relevant to the user and displaying it like a bulletin board defined by user interface 3102, thereby simplifying the user's job of browsing through multiple repositories and checking for the updates.

Embodiments herein can handle sending notifications to another, user moving a story/task into another state by fetching the necessary information for the user/based on user's input, changing the status of an existing task, autocompleting the task, sending reminders and the like.

Embodiments herein can provide bulletin board defined by user interface 3102 that offers a comprehensive overview of repository activities, integrating advanced generative AI technologies to automate routine tasks. By leveraging sophisticated machine learning algorithms, embodiments herein can provide real-time insights and predictive analytics, enhancing the workflow efficiency for development teams.

Embodiments herein can provide AI-driven automation. Embodiments herein can automate routine version control tasks, such as commit management, merge conflict resolution, and branch synchronization. Embodiments herein can provide real-time analytics. Embodiments herein can deliver instantaneous updates and visual representations of repository changes, commit histories, and branching activities. Embodiments herein can provide predictive insights. Embodiments herein can utilize generative AI to predict potential issues, recommend optimizations, and facilitate proactive decision-making. Embodiments herein can provide customizable notifications. Embodiments herein can ensures stakeholders are informed with tailored alerts and summaries based on their specific interests and roles. Embodiments herein can provide enhanced collaboration. Embodiments herein can promotes seamless collaboration among team members by providing a centralized platform for tracking progress and sharing updates. The described integration of generative AI into version control systems not only streamlines development processes but also fosters a more collaborative and informed working environment.

In an example user case a certain user can be associated to and have rights in multiple software project repositories. The user can be associated to repositories as follows. The user can be associated to (1) Mythat, which is a business product work on a daily basis, which is the code base repository for developers/testers/DevOps engineers. The user can also be associated to (2) a stretch assignments repository worked on collaboratively with other colleagues where there is handled a commondocument/codebase/PPT/flow chart and any document that is related to stretch work. The user can also be associated to (3) a project management repository where there is stored presentation, videos, guidelines, goals, templates, etc. The user can also be associated to (4) a third party subscription. The third party public git repository is used by the certain user for upskilling or as a reference for work.

In one use case, embodiments herein can include implementation stages set forth as follow. For a given user, manager system 110 can configure all the necessary (organizations/repositories) using: Any open-source workspace management package that supports development environments for different projects and different version of a project for different users. With all repositories under one project, manager system 110 can employ global regular expression point (grep) for discovery of all issues and issue tasks associated to a given user. grep refers to a command-line utility in Unix/Linux systems used to search for patterns in text files or outputs. Manager system 110 can employ grep for analyzing logs, filtering outputs, or searching for configuration settings.

Manager system 110 can check for issues and tasks associated with a PR. Issues and tasks associated to a PR can be flagged as code issues. Manager system 110 can flag remaining issues and associated user tasks as non-code issues.

Manager system 110 can create a data capture from a version controller's metadata using non-code input, storing up to N data captures for a predetermined amount of time. The last saved data capture can be displayed if the user does not select one of the two time frames. The user can define user input to select all or portion of the desired information. Input from the user can be defined to select the identified assignee or the preset group and calculate the difference in meta data between the study data captures using a run-time query. Manager system 110 can employ grep for analyzing data captures that have been updated from above run time query.

Manager system 110 can employ TextBlob to the last n comments. Embodiments herein recognize that TextBlob provides a simple API for analyzing common natural language processing (NLP) tasks such as part-of-speech tagging, noun phrase extraction, sentiment analysis, classification, translation, and subjectivity. Embodiments herein recognize that TextBlob can be used for common NLP tasks because it provides a simple and intuitive API that abstracts the complexities of natural language processing. Built on top of powerful libraries like NLTK and Pattern, it enables tasks such as sentiment analysis, tokenization, part-of-speech tagging, and spelling correction with minimal effort. For instance, it can analyze the polarity and subjectivity of a text, making it suitable for tasks like customer feedback analysis. It supports noun phrase extraction for identifying key elements in text and translation for multilingual applications. TextBlob's ability to handle tokenization and lemmatization simplifies text preprocessing for machine learning models. While it is not as scalable as advanced libraries like SpaCy or transformers, TextBlob's ease of use makes it ideal for beginners or small projects that require quick implementation of standard NLP tasks.

Manager system 110 can pass the polarity and subjectivity scores along with the content of last n comments to an LLM model of LLM area 2124. The polarity and subjectivity score will provide more context to the LLM. In the case of a code issue, a structured prompt can be presented to instruct the LLM to analyze the changes in the PR so that it can generate an appropriate priority score based on the changes. In some use cases, a structured prompt can be presented to result in a prioritization score is returned irrespective of whether a current task is associated to a code or non-code issue.

Manager system 110 can prompt the LLM to analyze the content along with the scores, severity, deadline and assign a priority score to each issue along with a summary of the issue.

Manager system 110 using the priority scores can sort and rank all tasks at hand based on priority with the highest priority task being first.

Manager system 110 can prompt the LLM to iterate over the priority queue, analyze every issue, generate a summary along with a web automation script (e.g. selenium script) that will autocomplete the given task at hand.

In the case of a code issue, manager system 110 can provide more context by allowing the LLM to analyze the code changes in the PR and generate priority score along with the summary/impact of the code changes.

Manager system 110 can determine that a code issue is present where an issue associated to a current task matches 1 or more of the following as set forth in Table A.

Manager system 110 can apply NLP and compute polarity parameter values and subjectivity parameter values on comments associated to a PR.

Manager system 110 can present a structured prompt to an LLM these parameter value scores along with the content of the issue/PR to the LLM for analysis and the LLM can generate a priority score and a summary. Then, manager system 100 can assign these tasks an ID and sort the tasks based on priority in descending order and a priority queue is created along with the code/non-code flag which can be presented on user interface 3102 defining a bulletin board dashboard. A newsletter-style representation of all the tasks at hand can be presented to the user. On user interface 3102 there can be presented controls to select automate (YES/NO) in addition to the newsletter view. After reviewing the task summary, the user can decide whether or not to automate a particular task with use of user interface 3102.

Manager system 110 can take up the highest priority task, and pass the information of that task through an LLM so it understands what must be done, provide suggestions and a summary for a dashboard defined by user interface 3102. If a code issue is present the LLM goes through the PR, understands the changes, creates a summary, has web automation script (e.g., selenium script) generated by the LLM to approve or enter into a software project repository use comments associated the PR.

The web automation script (e.g., selenium script) can be generated, saved locally and is waiting for the user's approval. If the user selects “yes”, the generated web automation script selenium script can be saved locally on the user's machine and executed. System 100 can be configured so that the web automation script can be deleted after execution and the task is removed from the priority queue. If the user selects “no”, manager system 110 can add the task to a “to be done manually” list. Manager system 110 can create a separate view on the dashboard defined by user interface 3102 for tasks to be done manually with all the information and summary generated by the LLM and remove it from the priority queue. The same can be done for non-code as well. For code and/or non-code issues, manager system 110 can present structured prompts to an LLM to request the LLM generate a detailed explanation and an automation script to comment on the task at hand.

Various available tools, libraries, and/or services can be utilized for implementation of trained predictive models herein trained by machine learning, such as LLMs of LLM area 2124. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

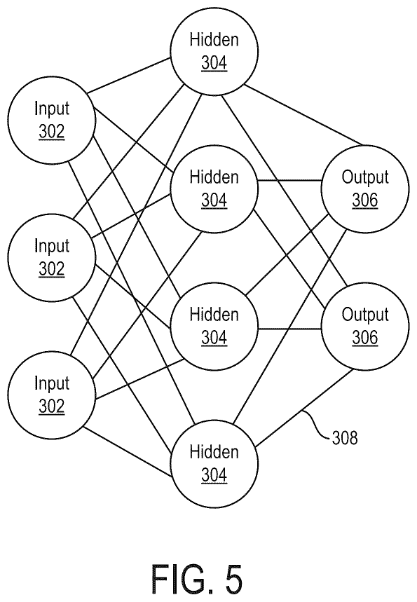

FIG. 5 is an illustration of an example ANN architecture for trained predictive models herein trained by machine learning, such as one or more LLM of LLM area 2124.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN can be configured for a specific application, such as the applications discussed in connection with predictive models herein.

Referring now to FIG. 5, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referring to as outcome training data as referenced in connection with predictive models herein, such as one or more LLM stored in LLM area 2124. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein may offer various technical computing advantages involving computing advantages to address problems arising in the realm of computer systems. Embodiments herein can automate and accelerate issues present within a software project repository including core branch code issues. Embodiment herein can assure and/or accelerate the remediation of core branch code issues foundational to operation of an application or service. Embodiments herein can include automated processes to capture repository data and process captured data for return of identifying data that specifies current tasks for performance by a certain user, categorization data that categorizes tasks as code or non-code tasks, and classification data that classifies code tasks into conflict code tasks and non-conflict code tasks. Embodiments herein can include features for preventing failure of active codebase code and features for improved performance of active codebase code. In one aspect, embodiments herein can include features for restricting the incorporation of failure inducing code into a codebase. In a human in the loop aspect, embodiments herein can include features for automated updating of a codebase, conditional on a check for a code conflict. A user can be presented with controls for automated updating of a codebase with computer system protections being active which restrict the presentment of such controls in that case that a code task presents a conflict with a codebase. Embodiments herein can feature structured prompts for prompting one or more LLM. Structured prompts can be structured for return a prioritization data that prioritizes tasks, return of summary data that summarizes tasks, and/or return of web automation script for performance of tasks. Embodiments herein can include generating user prompting data for prompting the user with the use of a presented user interface. Prompting data can separate tasks into code issues and non-code issues and can permit the user to view a prioritized list of tasks. With use of a user interface herein, a user can elect to view code issues as distinct from non-code issues. The user interface can include selection buttons which when activated activate web automation script for completion of tasks. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription

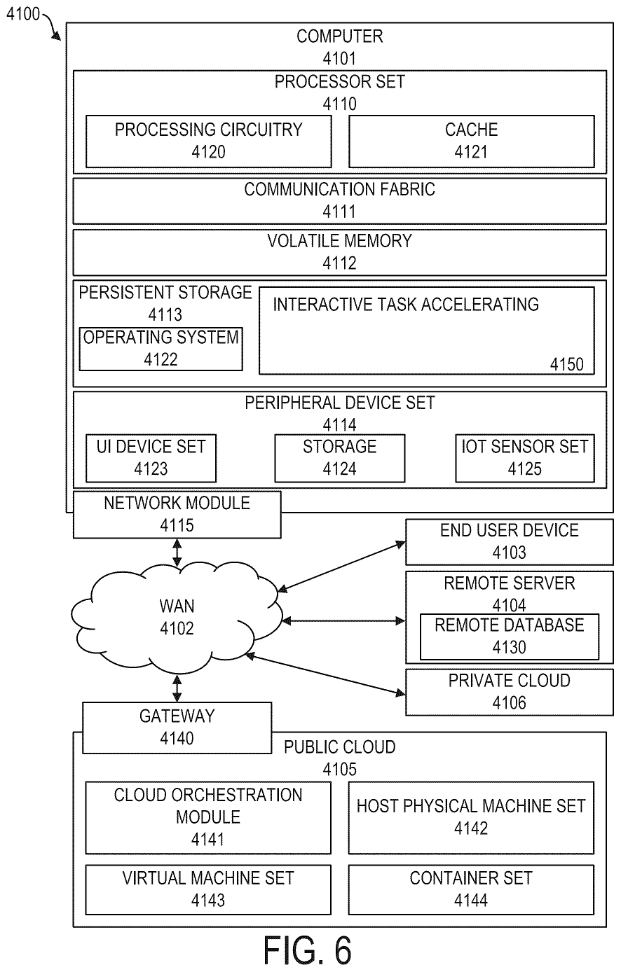

In reference to FIG. 6 there is set forth a description of a computing environment 4100 that can include one or more computer 4101. In one example, a computing node as set forth herein can be provided in accordance with computer 4101 as set forth in FIG. 6.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Hash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 6. In one aspect, a computing environment 4100 contains an example of an environment for the execution of at least some of the computer code involved in performing the inventive methods, such as code 4150 for interactive task accelerating described with reference to FIGS. 1-5. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

URLs herein have been presented with syntax violating characters herein, e.g., “*”, to avoid the presentment of active links in the current document.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining repository data of first through Nth multi-user software project repositories, wherein the first through Nth multi-user software project repositories provide support for respective first through Nth differentiated software projects;
identifying, from the examining, current tasks for performance by a certain user, wherein the certain user is associated to respective ones of the first through Nth multi-user software project repositories;
generating user prompting data in dependence on the identifying; and
presenting the user prompting data generated by the generating to the certain user, wherein the presenting includes presenting a user interface to the certain user, the user interface including the user prompting data.

2. The computer implemented method of claim 1, wherein the method includes performing a code conflict check for a code task of the identified current tasks, and responsively to a result of the performing, producing user activatable code for completion of the code task.

3. The computer implemented method of claim 1, wherein the method includes performing a code conflict check for a code task of the identified current tasks, and responsively to a result of the performing, producing user activatable code for completion of the code task, and wherein the generating includes performing the generating so that a control for activation of the user activatable code is included in the user interface.

4. The computer implemented method of claim 1, wherein the method includes performing a code conflict check for a code task of the identified current tasks, and responsively to a result of the performing, producing user activatable code for completion of the code task, and wherein the generating includes performing the generating so that a control for activation of the user activatable code is included in the user interface.

5. The computer implemented method of claim 1, wherein the method includes performing a code conflict check for a code task of the identified current tasks, and responsively to a result of the performing, producing user activatable code for completion of the code task, wherein the generating includes performing the generating so that a control for activation of the user activatable code is included in the user interface, and wherein the producing user activatable code for completion of the code task includes sending a structured prompt to a language model for return of the user activatable code, wherein the structured prompt include (a) template text, (b) variable text, the variable text being in dependence on metadata that was processed for identifying the code task by the identifying, and (c) a text based request to produce the user activatable code, wherein the text based request is defined by text of the template text.

6. The computer implemented method of claim 1, wherein the method includes performing a code conflict check for a code task of the identified current tasks, and responsively to a result of the performing, producing user activatable code for completion of the code task, and wherein the generating includes performing the generating so that a control for activation of the user activatable code is included in the user interface, wherein the method includes executing a code conflict check for a second code task of the identified current tasks, and responsively to a result of the executing indicating that the second code task presents a code conflict, restricting a manager system from producing user activable code for completion of the second code task.

7. The computer implemented method of claim 1, wherein the method includes performing a code conflict check for a code task of the identified current tasks, and responsively to a result of the performing, producing user activatable code for completion of the code task, and wherein the generating includes performing the generating so that a control for activation of the user activatable code is included in the user interface, wherein the method includes executing a code conflict check for a second code task of the identified current tasks, and responsively to a result of the executing indicating that the second code task presents a code conflict, restricting, by a manager system, producing of user activable code for completion of the second code task, and wherein the producing user activatable code for completion of the code task includes sending a structured prompt to a language model for return of the user activatable code, wherein the structured prompt include (a) template text, (b) variable text, the variable text being in dependence on metadata of the repository data, and (c) a text based request to produce the user activatable code, wherein the text based request is defined by text of the template text.

8. The computer implemented method of claim 1, wherein the method includes categorizing a certain task of the current tasks identified by the identifying as a non-code task, categorizing a particular task for the current tasks identified by the identifying as a code task, selecting a first structured prompt configuration having first template text in dependence on the certain task being categorized as a non-code task, selecting a second structured prompt configuration having second template text in dependence on the particular task being categorized as a code task, wherein the second template text is differentiated from the first template text, prompting language model to create a certain summary of the certain task using the first structured prompt configuration, and prompting a model to create a particular summary of the particular task using the second structured prompt configuration.

9. The computer implemented method of claim 1, wherein the method includes producing web automation script for performance of one or more task of the identified task, and wherein the generating includes performing the generating so that a control for activation of the web automation script is included in the user interface.

10. The computer implemented method of claim 1, wherein the method includes producing web automation script for performance of one or more task of the identified task, and wherein the user interface, as a result of the generating, includes a button for activation of the web automation script.

11. The computer implemented method of claim 1, wherein the method includes prioritizing tasks of the identified current tasks.

12. The computer implemented method of claim 1, wherein the method includes prioritizing tasks of the identified current tasks, wherein the prioritizing includes prompting a large language model (LLM).

13. The computer implemented method of claim 1, wherein the method includes categorizing tasks of the identified tasks as code or non-code tasks.

14. The computer implemented method of claim 1, wherein the method includes classifying code tasks of the identified tasks as conflicted code tasks or not-conflicted code tasks.

15. The computer implemented method of claim 1, wherein the method includes prioritizing tasks of the identified current tasks, wherein the prioritizing includes applying a structured prompt to a large language model, wherein the structured prompt includes (a) template text, (b) variable text, the variable text being in dependence on metadata that was processed for identifying a certain task by the identifying, and (c) a text based request to output a prioritization score for the certain task, wherein the text based request is defined by text of the template text.

16. The computer implemented method of claim 1, wherein the method includes processing metadata from a certain data source for identifying a certain task of the current tasks, subjecting comment data from the certain data source for obtaining a sentiment and subjectivity natural language parameter values for the certain task, prioritizing tasks of the identified current tasks, wherein the prioritizing includes applying a structured prompt to a large language model, wherein the structured prompt includes (a) template text, (b) variable text, the variable text being in dependence on textual data of the metadata, (c) the sentiment and subjectivity natural language parameter values, and (d) a text based request to output a prioritization score for the certain task, wherein the text based request is defined by text of the template text.

17. The computer implemented method of claim 1, wherein the method includes, for obtaining the repository data of the first through Nth multi-user software project repositories, sending API calls to multiple service endpoints of respective one of the first through Nth multi-user software project repositories, the multiple service endpoints including endpoint for obtaining (i) Commit metadata, (ii) Pull request (PR) metadata, (iii) Branch metadata, and (iv) Test status metadata.

18. The computer implemented method of claim 1, wherein the method includes performing a code conflict check for a code task of the identified current tasks, and responsively to a result of the performing, producing user activatable code for completion of the code task, and wherein the generating includes performing the generating so that a control for activation of the user activatable code is included in the user interface, wherein the method includes executing a code conflict check for a second code task of the identified current tasks, and responsively to a result of the executing indicating that the second code task presents a code conflict, restricting, by a manager system, producing of user activable code for completion of the second code task, and wherein the producing user activatable code for completion of the code task includes sending a structured prompt to a language model for return of the user activatable code, wherein the structured prompt include (a) template text, (b) variable text, the variable text being in dependence on metadata of the repository data, and (c) a text based request to produce the user activatable code, wherein the text based request is defined by text of the template text, wherein the method includes processing metadata from a certain data source for identifying a certain task of the current tasks, subjecting comment data from the certain data source for obtaining a sentiment and subjectivity natural language parameter values for the certain task, prioritizing tasks of the identified current tasks, wherein the prioritizing includes applying a structured prompt to a large language model, wherein the structured prompt includes (i) template text, (ii) variable text, the variable text being in dependence on textual data of the metadata, (iii) the sentiment and subjectivity natural language parameter values, and (iv) a text based request to output a prioritization score for the certain task, wherein the text based request is defined by text of the template text, wherein the method includes producing web automation script for performance of one or more task of the identified task, wherein the generating includes performing the generating so that a control for activation of the web automation script is included in the user interface, and wherein the generating includes performing the generating so text based data specifying a ranked order of tasks of the identified tasks is included on the user interface.

19. A system comprising:
a memory;
at least one processor in communication with the memory; and
program instructions executable by one or more processor via the memory to perform operations comprising:
examining repository data of first through Nth multi-user software project repositories, wherein the first through Nth multi-user software project repositories provide support for respective first through Nth differentiated software projects;
identifying, from the examining, current tasks for performance by a certain user, wherein the certain user is associated to respective ones of the first through Nth multi-user software project repositories;
generating user prompting data in dependence on the identifying; and
presenting the user prompting data generated by the generating to the certain user, wherein the presenting includes presenting a user interface to the certain user, the user interface including the user prompting data.

20. A computer program product comprising:
a computer readable storage medium readable by one or more processing circuit and storing instructions for execution by one or more processor for performing operations comprising:
examining repository data of first through Nth multi-user software project repositories, wherein the first through Nth multi-user software project repositories provide support for respective first through Nth differentiated software projects;
identifying, from the examining, current tasks for performance by a certain user, wherein the certain user is associated to respective ones of the first through Nth multi-user software project repositories;
generating user prompting data in dependence on the identifying; and
presenting the user prompting data generated by the generating to the certain user, wherein the presenting includes presenting a user interface to the certain user, the user interface including the user prompting data.
